(19) United States
(12) Patent Application Publication
(10) Pub. No.: US 2019/0026837 A1
(43) Pub. Date: Jan. 24, 2019

(54) INSURANCE PROVIDING APPARATUS, INSURANCE PROVIDING METHOD, AND COMPUTER READABLE RECORDING MEDIUM WITH COMPUTER PROGRAM RECORDED THEREON

(71) Applicant: Masahiro TAKASAKI, Tokyo (JP)

(72) Inventor: Yoshikazu TAKASAKI, Tokyo (JP)

(21) Appl. No.: 16/064,514

(22) PCT Filed: Dec. 7, 2016
(86) PCT No.: PCT/JP2016/086299

§ 371 Date: Jun. 21, 2018

(30) Foreign Application Priority Data
Dec. 22, 2015 (JP) 2015-249425

(51) Int. Cl. G06Q 40/08; G06Q 10/10; G06Q 10/06

(52) U.S. Cl. CPC G06Q 40/08; G06Q 10/063; G06Q 10/10

(57) ABSTRACT

PROBLEM: To provide insurance specific to individual workers with a reasonable premium being calculated from actual conditions of a worker based on the personnel labor information of the worker, and the calculated premium being set.

SOLUTION: An insurance providing apparatus 1, which provides insurance based on personnel labor information specific to a worker with a premium being set for the worker according to the changing personnel labor information, is configured so as to be capable of communicating through a network NW with a personnel labor information management apparatus 2, and has an insurance information DB 1A in which is stored insurance information comprising insurance subscription conditions based on personnel labor information, and calculations standards of premiums that are set according to the personnel labor information. A determination processing unit 12 references a personnel labor information DB 2A and the insurance information DB 1A, and determines the possibility of subscription of a worker to a prescribed insurance, and if the determination results indicate that the worker satisfies the conditions for subscription to the prescribed insurance, a calculation processing unit 13 calculates a premium to be imposed on the worker based on the premium calculation standards and the personnel labor information of the worker.

### TECHNICAL FIELD

The present invention relates to a feature for preparing insurance in accordance with personnel labor information of a worker.

### BACKGROUND ART

In the current state, the system for various types of insurance such as life insurance, casualty insurance, or annuity insurance is such that premiums differ based on differences such as age and gender, and everyone with the same conditions pays the same premium.

The main reason for this type of system is that clerical processing becomes complex, and management and tabulation are cumbersome. Therefore, contract updates are made approximately once every few years, and premium amounts are not varied monthly or even yearly.

Patent document 1 proposes a system in which insurance companies propose insurance based on a customer's current insurance subscription information and the customer's needs such as services desired for the future, details of desired guarantees, and bearable premiums, and one insurance with the greatest cost effectiveness or an optimum combination comprising a plurality of insurances is selected and proposed to the customer to thereby prompt the customer to form a contract for the best insurance meeting the customer's needs, and as can be understood from patent document 1, with this type of system for example, insurance according to the circumstances of a worker, and particularly according to job-related personnel labor information, and insurance for which the premium is set are not provided by conventional insurance proposals.

### PRIOR ART DOCUMENTS

### Patent Documents

[Patent Document 1] Japanese Laid-open Patent Publication No. 2002-056191

### DISCLOSURE OF THE INVENTION

### Problem to be Solved by the Invention

However, from the perspective of an insurance subscriber who pays a premium, conventional insurance is difficult to understand and accept, and generates a sense of unfairness. For example, consider the case of an employee with no stress who is a veteran with many years of continuous service, who is not engaged in a dangerous job, does not work overtime or on holidays, and who commutes a short distance using a safe transportation means, and the case of an employee with a significant amount of stress who works in a dangerous location, works a lot of overtime and often works on holidays, who commutes a long distance on a motorbike, and who has only a short number of years of continuous service. If both employees are of the same gender and age, the premium that would be demanded when subscribing to the same insurance product would be the same regardless of the differences in work conditions.

The present invention eliminates this kind of sense of unfairness, it being an object thereof to provide insurance specific to each worker for which a reasonable premium is calculated from the actual conditions of the worker on the basis of the personnel labor information of the worker, and for which the calculated premium is set.

### Means for Solving the Problem

To achieve the object, an insurance providing apparatus according to one aspect of the present invention provides insurance that is based on personnel labor information specific to a worker, a premium being set for the worker according to the changing personnel labor information. The insurance providing apparatus is characterized in being configured so as to be capable of communicating through a network with a personnel labor information management apparatus having personnel labor information storage means in which personnel labor information specific to the worker is stored. The insurance providing apparatus comprising:

insurance information storage means in which is stored insurance information regarding insurance to be offered to the worker, the insurance information comprising details of the insurance, insurance subscription conditions based on the personnel labor information, and calculation standards for a premium to be set according to the personnel labor information;

determination processing means which references the personnel labor information storage means and the insurance information storage means, and determines the possibility of subscription of the worker to a prescribed insurance on the basis of the personnel labor information of the worker and subscription conditions for the insurance; and

calculation processing means, which for a case in which the worker satisfies subscription conditions for the prescribed insurance based on the results of the determination of the subscription possibility, references the personnel labor information storage means and the insurance information storage means, and calculates a premium to be imposed on the worker for the prescribed insurance on the basis of the premium calculation standard and the personnel labor information of the worker.

It is also possible to have the insurance providing apparatus is configured so as to be capable of further communicating through a network with a worker terminal used by the worker, and further comprising:

application reception means for receiving an application regarding a contract for the prescribed insurance from the worker terminal for a case in which the worker satisfies the subscription conditions for the prescribed insurance based on the results of the determination of the possibility of subscription; and

contract information storage means for storing information of an insurance contract concluded according to the application.

It is also possible to have the insurance providing apparatus, further comprising:

premium information transmission means for transmitting to the worker terminal, information relating to a premium newly calculated at each prescribed timing;

approval information reception means for receiving approval information relating to the newly calculated premium from the worker terminal; and

update processing means for updating and registering information relating to the approved premium in the contract information storage means;

the calculation processing means further referencing the personnel labor information storage means, the insurance information storage means, and the contract information storage means at every prescribed timing, and newly calculating a premium for insurance for which the contract has been concluded.

It is also possible to have the insurance providing apparatus, further comprising:

deduction request transmission means for transmitting, to the personnel labor information management apparatus, information relating to the premium of the concluded insurance, along with a request to deduct the premium.

It is also possible to have the insurance providing apparatus, further comprising:

deduction request transmission means for transmitting, to the personnel labor information management apparatus, information relating to the premium of the concluded insurance, along with a request to deduct the premium.

An insurance providing apparatus according to another configuration of the present invention provides insurance based on personnel labor information specific to a worker, a premium being set for the worker according to the changing personnel labor information; wherein

the insurance providing apparatus is characterized in being configured so as to be capable of communicating through a network with: a personnel labor information management apparatus having personnel labor information storage means in which personnel labor information specific to the worker is stored, and a worker terminal used by the worker; and the insurance providing apparatus comprises:

insurance information storage means in which is stored insurance information regarding insurance to be offered to the worker, the insurance information comprising details of the insurance, insurance subscription conditions based on the personnel labor information, and calculation standards for a premium to be set according to the personnel labor information;

determination processing means which references the personnel labor information storage means and the insurance information storage means, and determines the possibility of subscription of the worker to a prescribed insurance on the basis of the personnel labor information of the worker and subscription conditions for the insurance;

first calculation processing means, which for a case in which the worker satisfies subscription conditions for the prescribed insurance based on the results of the determination of the subscription possibility, references the personnel labor information storage means and the insurance information storage means, and calculates a premium to be imposed on the worker for the prescribed insurance on the basis of the premium calculation standard and the personnel labor information of the worker;

application reception means for receiving, from the worker terminal, an application regarding a contract for insurance for which the premium was calculated;

contract information storage means for storing information of an insurance contract concluded according to the application;

second calculation processing means which references, at every prescribed timing, the personnel labor information storage means, the insurance information storage means, and the contract information storage means, and newly calculates a premium for insurance for which the contract was concluded;

premium information transmission means for transmitting information relating to a premium newly calculated at each prescribed timing to the worker terminal;

approval information reception means for receiving approval information relating to the newly calculated premium from the worker terminal; and

update processing means for updating and registering information relating to the approved premium in the contract information storage means.

It is also possible to have the insurance providing apparatus, further comprising:

contract information transmission means for transmitting the concluded or updated insurance contract information to the personnel labor information management apparatus.

An insurance providing method according to another aspect of the present invention provides insurance based on personnel labor information specific to a worker, a premium being set for the worker according to the changing personnel labor information;

the insurance being provided through a computer configured so as to be capable of communicating through a network with a personnel labor information management apparatus having personnel labor information storage means in which personnel labor information specific to the worker is stored, and

the computer having insurance information storage means in which is stored insurance information regarding insurance to be offered to the worker, the insurance information comprising details of the insurance, insurance subscription conditions based on the personnel labor information, and calculation standards for a premium to be set according to the personnel labor information;

wherein the insurance providing method is characterized by executing:

determination processing for referencing the personnel labor information storage means and the insurance information storage means, and determining the possibility of subscription of the worker to a prescribed insurance on the basis of the personnel labor information of the worker and subscription conditions for the insurance; and

calculation processing in which for a case in which the worker satisfies subscription conditions for the prescribed insurance based on the results of the determination of the subscription possibility, the personnel labor information storage means and the insurance information storage means are referenced, and a premium to be imposed on the worker for the prescribed insurance is calculated on the basis of the premium calculation standard and the personnel labor information of the worker.

An insurance providing method according to another configuration of the present invention provides insurance based on personnel labor information specific to a worker, a premium being set for the worker according to the changing personnel labor information;

the insurance being provided by a computer configured so as to be capable of communicating through a network with: a personnel labor information management apparatus having personnel labor information storage means in which personnel labor information specific to the worker is stored, and a worker terminal used by the worker, and

the computer having insurance information storage means in which is stored insurance information regarding insurance to be offered to the worker, the insurance information comprising details of the insurance, insurance subscription conditions based on the personnel labor information, and calculation standards for a premium to be set according to the personnel labor information;

wherein the insurance providing method is characterized in that the following are executed:

determination processing for referencing the personnel labor information storage means and the insurance information storage means, and determining the possibility of subscription of the worker to a prescribed insurance on the basis of the personnel labor information of the worker and subscription conditions for the insurance;

first calculation processing in which for a case in which the worker satisfies subscription conditions for the prescribed insurance based on the results of the determination of the subscription possibility, the personnel labor information storage means and the insurance information storage means are referenced, and a premium to be imposed on the worker for the prescribed insurance is calculated on the basis of the premium calculation standard and the personnel labor information of the worker;

application reception processing for receiving, from the worker terminal, an application regarding a contract for insurance for which the premium was calculated;

processing to store in contract information storage means, information of an insurance contract concluded according to the application;

second calculation processing for referencing, at every prescribed timing, the personnel labor information storage means, the insurance information storage means, and the contract information storage means, and newly calculating a premium for insurance for which the contract was concluded;

premium information transmission processing for transmitting information relating to a premium newly calculated at each prescribed timing to the worker terminal;

approval information reception processing for receiving approval information relating to the newly calculated premium from the worker terminal; and

update processing for updating and registering information relating to the approved premium in the contract information storage means.

A computer program according to another aspect of the present invention causes a computer to function as an insurance providing apparatus, wherein:

the computer being configured so as to be capable of communicating through a network with a personnel labor information management apparatus having personnel labor information storage means in which personnel labor information specific to a worker is stored, and

the computer having insurance information storage means in which is stored insurance information regarding insurance to be offered to the worker, the insurance information comprising details of the insurance, insurance subscription conditions based on the personnel labor information, and calculation standards for a premium to be set according to the personnel labor information;

wherein the computer program causes functioning as an insurance providing apparatus for providing insurance based on personnel labor information specific to the worker, a premium being set for the worker according to the changing personnel labor information;

and the computer program causes the computer to execute:

determination processing for referencing the personnel labor information storage means and the insurance information storage means, and determining the possibility of subscription of the worker to a prescribed insurance on the basis of the personnel labor information of the worker and subscription conditions for the insurance; and

calculation processing in which for a case in which the worker satisfies subscription conditions for the prescribed insurance based on the results of the determination of the subscription possibility, the personnel labor information storage means and the insurance information storage means are referenced, and a premium to be imposed on the worker for the prescribed insurance is calculated on the basis of the premium calculation standard and the personnel labor information of the worker.

A computer program according to another configuration of the present invention causes a computer to function as an insurance providing apparatus, wherein:

the computer being configured so as to be capable of communicating through a network with: a personnel labor information management apparatus having personnel labor information storage means in which personnel labor information specific to a worker is stored, and a worker terminal used by the worker, and

the computer having insurance information storage means in which is stored insurance information regarding insurance to be offered to the worker, the insurance information comprising details of the insurance, insurance subscription conditions based on the personnel labor information, and calculation standards for a premium to be set according to the personnel labor information;

wherein the computer program causes functioning as an insurance providing apparatus for providing insurance based on personnel labor information specific to the worker, a premium being set for the worker according to the changing personnel labor information;

and the computer program causes the computer to execute:

determination processing for referencing the personnel labor information storage means and the insurance information storage means, and determining the possibility of subscription of the worker to a prescribed insurance on the basis of the personnel labor information of the worker and subscription conditions for the insurance;

first calculation processing in which for a case in which the worker satisfies subscription conditions for the prescribed insurance based on the results of the determination of the subscription possibility, the personnel labor information storage means and the insurance information storage means are referenced, and a premium to be imposed on the worker for the prescribed insurance is calculated on the basis of the premium calculation standard and the personnel labor information of the worker;

application reception processing for receiving, from the worker terminal, an application regarding a contract for insurance for which the premium was calculated;

processing to store information of an insurance contract concluded according to the application in contract information storage means;

second calculation processing for referencing, at every prescribed timing, the personnel labor information storage means, the insurance information storage means, and the contract information storage means, and newly calculating a premium for insurance for which the contract was concluded;

premium information transmission processing for transmitting information relating to a premium newly calculated at each prescribed timing to the worker terminal;

approval information reception processing for receiving approval information relating to the newly calculated premium from the worker terminal; and

update processing for updating and registering information relating to the approved premium in the contract information storage means.

### Effect of the Invention

The present invention provides insurance specific to each worker for which a reasonable premium is calculated from the actual conditions of the worker on the basis of the personnel labor information of the worker, and for which the calculated premium is set.

### BRIEF DESCRIPTION OF THE DRAWINGS

FIG. 1 is a functional block diagram showing functions of an insurance providing apparatus according to an embodiment of the present invention;

FIG. 2 is a table showing an example of data stored in an insurance information database (DB) of the insurance providing apparatus according to the present embodiment;

FIG. 3 is a table showing an example of data stored in a contract information DB of the insurance providing apparatus according to the present embodiment;

FIG. 4 is a table showing an example of data stored in a personnel labor information DB of the insurance providing apparatus according to the present embodiment;

FIG. 5 is a sequence diagram showing the flow of processing to be executed by the insurance providing apparatus according to the present embodiment;

FIG. 6 is a sequence diagram showing the flow of processing to be executed by the insurance providing apparatus of the present embodiment;

FIG. 7 is a sequence diagram showing the flow of processing to be executed by the insurance providing apparatus according to the present embodiment;

FIG. 8 is a sequence diagram showing the flow of processing to be executed by the insurance providing apparatus according to the present embodiment.

### BEST MODE FOR CARRYING OUT THE INVENTION

Next, an insurance providing apparatus according to an embodiment of the present invention will be described.

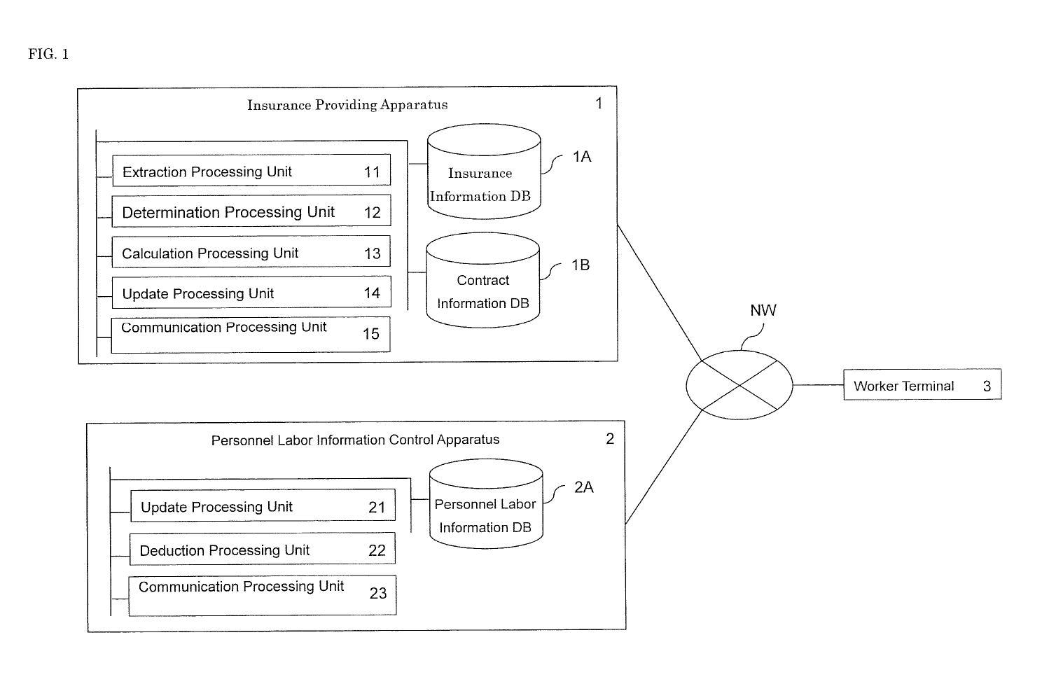

As shown in FIG. 1, an insurance providing apparatus 1 according to the present embodiment provides insurance that has been caused to correspond individually to each worker, and is configured so as to be capable of communicating with a personnel labor information management apparatus 2 and a worker terminal 3 through a network NW.

The insurance providing apparatus 1 is realized through a “server computer,” etc., and configures a functional block comprising an extraction processing unit 11, a determination processing unit 12, a calculation processing unit 13, an update processing unit 14, a communication processing unit 15, an insurance information DB 1A, and a contract information DB 1B through hardware resources such as a central processing unit (CPU), random access memory (RAM), read only memory (ROM), and a hard disk drive, and software resources such as a computer program executed by the CPU.

The insurance information DB 1A is a storage unit in which information related to insurance as an insurance product offered to a worker is stored.

The insurance stored in this insurance information DB 1A is configured so that a premium is set on the basis of personnel labor information of the worker, and the premium is calculated through premium calculation processing by the calculation processing unit 13.

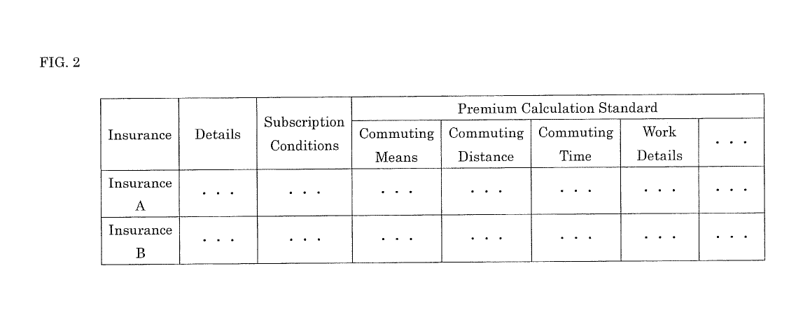

More specifically, as shown in FIG. 2, insurance details, insurance subscription conditions based on the personnel labor information of the worker, and premium calculation standards set in accordance with the personnel labor information are associated and stored in the insurance information DB 1A for each insurance that can be offered to a worker.

Information relating to insurance subscription conditions is information indicating that conditions based on the personnel labor information of the worker are satisfied, such as for example, information that indicates that a worker with more than five years of continuous service, an absentee rate of within 3%, and a late arrival and early departure rate of within 0.5% satisfies the conditions for subscription of the prescribed insurance.

Moreover, for information relating to the premium calculation standard, numeric figures that form the basis for calculations for each detail constituting personnel labor information such as the worker's commuting means, commuting distance, commuting time, work details, task details, business travel percentage, business travel destination, overtime percentage, overtime hours, holiday work attendance percentage, number of times of holiday work, etc. are established. Through this, the amount of the premium can be calculated for cases in which a person engages in prescribed work with safe details and who uses safe public transportation as commuting means.

The contract information DB 1B is a storage unit in which information of an insurance contract concluded with a worker is stored.

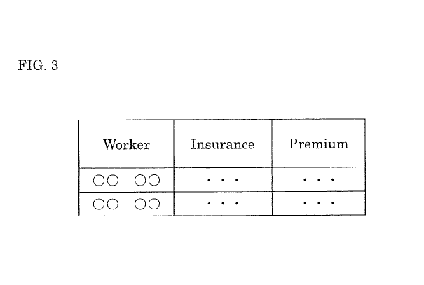

The contract information stored in this contract information DB 1B is constituted, as shown in FIG. 3 for example, of the worker with which the insurance contract was concluded, the concluded insurance, and the premium set for the insurance, etc.

The extraction processing unit 11 extracts personnel labor information, insurance information, and contract information, which are necessary when offering insurance, from the personnel labor information DB 2A of the personnel labor information management apparatus 2, the insurance information DB 1A, and the contract information DB 1B*¹.

The determination processing unit 12 references the personnel labor information DB 2A and the insurance information DB 1A, and executes determination processing to determine the possibility of subscription of a worker to a prescribed insurance on the basis of the personnel labor information of the worker and the insurance subscription conditions.

For a case in which the worker satisfies the prescribed insurance subscription conditions based on the results of determination processing by the determination processing unit 12, the calculation processing unit 13 references the personnel labor information DB 2A and the insurance information DB 1A, and executes processing to calculate the premium to be imposed on the worker for the prescribed insurance on the basis of the premium calculation standard and the personnel labor information of the worker.

If the premium for insurance for which a contract has been concluded with a worker has been changed according to a change in the personnel labor information, the update processing unit executes processing to update and register the newly calculated insurance premium in the contract information DB 1B.

The communication processing unit 15 executes data transmission and reception processing between the personnel labor information management apparatus 2 and the worker terminal 3 through the network NW.

The personnel labor information management apparatus 2 manages personnel labor information relating to the personnel affairs and labor of the worker.

This personnel labor information management apparatus 2 is realized through a “server computer,” etc., and configures a functional block comprising an update processing unit 21, a deduction processing unit 22, a communication processing unit 23, and a personnel labor information DB 2A through hardware resources such as a central processing unit (CPU), random access memory (RAM), read only memory (ROM), and a hard disk drive, and software resources such as a computer program executed by the CPU.

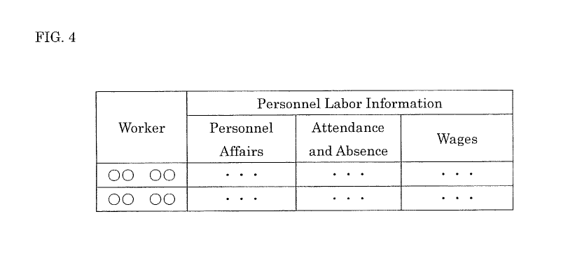

The personnel labor information DB 2A is a storage unit in which personnel labor information of the worker is stored, and as shown in the example of FIG. 4, personnel labor information such as personnel affairs, attendance and absence information, and wages is associated and stored for each worker.

This personnel labor information includes information of insurance contracts concluded with the worker and provided by the insurance providing apparatus 1 according to the present embodiment.

If a change has been made to the personnel labor information of a worker, the update processing unit 21 updates and registers the changed personnel labor information in the personnel labor information DB 2A.

This updated and registered information includes information relating to insurance contracted by the worker, and for example, if a premium is changed with the approval of the worker, information relating to the premium after the change is updated and registered.

The deduction processing unit 22 executes deduction processing for deducting a prescribed premium from wages on the basis of a request from the insurance providing apparatus 1.

This deduction processing references the personnel labor information of the worker stored in the personnel labor information DB 2A, and deducts the premium requested by the insurance providing apparatus 1 from the wages. Through this, wages from which the premium has been deducted are then paid to the worker.

The communication processing unit 23 executes data transmission and reception processing with the insurance providing apparatus 1 through the network NW.

The worker terminal 3 is a terminal used by the worker, is configured by a “personal computer”, etc., and is configured so that communication with the insurance providing apparatus 1 is possible through the network NW.

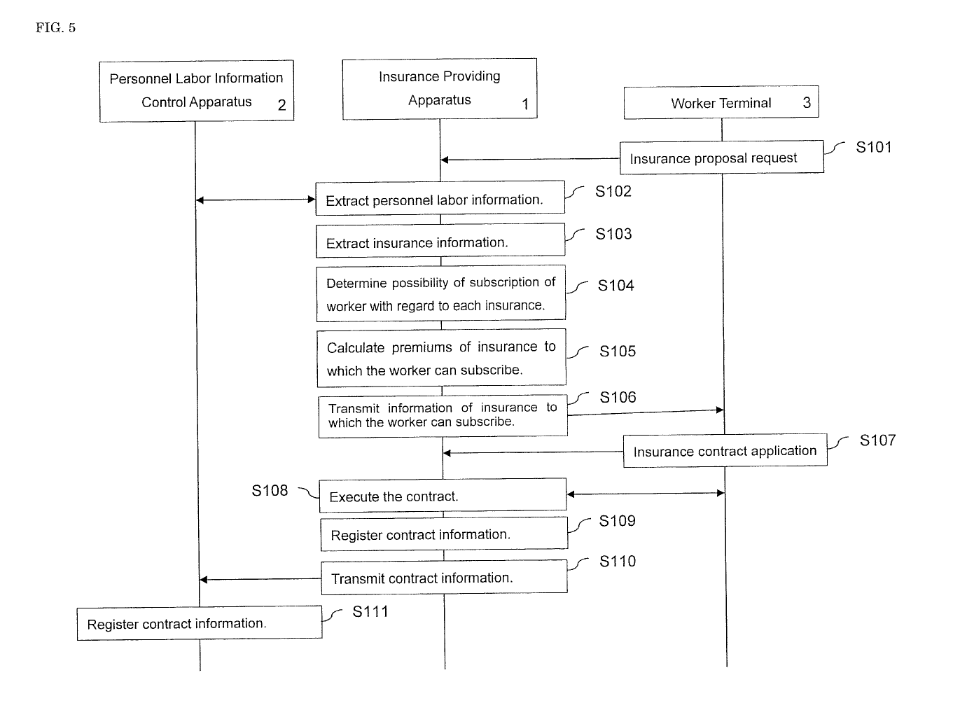

Next, the flow of processing for offering individual insurance to each worker will be described with reference to FIG. 5.

First, an insurance proposal request is transmitted from the worker to the insurance providing apparatus 1 through the worker terminal 3 (S101).

In response thereto, the insurance providing apparatus 1 uses the extraction processing unit 11 to extract the personnel labor information of the worker from the personnel labor information DB 2A of the personnel labor information management apparatus 2 (S102), and to extract insurance information from the insurance information DB 1A (S103).

Furthermore, the determination processing unit 12 determines the possibility of subscription of the worker with regard to each item of insurance information on the basis of the personnel labor information of the worker (S104). That is, the determination processing unit 12 determines whether the personnel labor information of the worker satisfies the subscription conditions established for each insurance.

Furthermore, regarding insurance for which it has been determined, as a result of the determination processing by the determination processing unit 12, that the worker can subscribe, the calculation processing unit 13 calculates the premium set for the worker (S105).

The premium thereof is calculated based on the personnel labor information of the worker and the premium calculation standard stipulated for the insurance.

In response thereto, a list of information of insurances to which the worker can subscribe is transmitted to the worker terminal 3 (S106). At this time, the various types of insurance information provided to the worker include the premiums calculated for each insurance.

The worker to whom premium information and the list of information of insurances to which the worker can subscribe were presented from the insurance providing apparatus 1 selects a desired insurance, and transmits an application for an insurance contract to the insurance providing apparatus 1 (S107).

In response thereto, the insurance providing apparatus 1 executes an exchange with the worker of various procedures, etc. necessary to conclude the insurance contract, and concludes the insurance contract (S108).

The information pertaining to the concluded insurance contract is registered in the contract information DB 1B (S109).

Furthermore, the contract information is provided to the personnel labor information management apparatus 2 (S110), and the personnel labor information management apparatus 2 that has received the contract information references the personnel labor information DB 2A, and updates the contract information with respect to the personnel labor information of the worker through the update processing unit 21 (S111).

Through this, insurance for which a reasonable premium has been set in accordance with the personnel labor information of the worker is offered to the worker.

Thus, the insurance offered to the worker can be configured so that the premium also changes in accordance with changes in the personnel labor information of the worker.

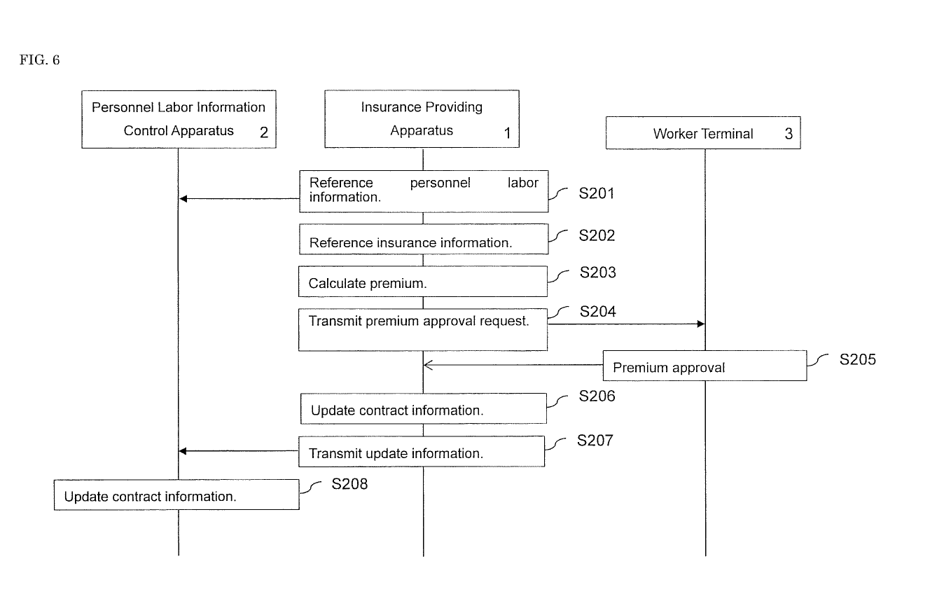

FIG. 6 shows an example of processing for case of configuring in this manner.

The insurance providing apparatus 1 references the worker's personnel labor information stored in the personnel labor information DB 2A at a prescribed timing such as once a month, once a week, or at the time of premium payment (S201).

The insurance providing apparatus 1 also references, in the insurance information DB 1A, insurance information of insurance for which a contract has been signed by the worker (S202), and calculates the premium based on the referenced personnel labor information using the calculation processing unit 13 (S203). If a change in the personnel labor information is present at this time, a premium of an amount that differs from the amount contracted until now is newly calculated.

The insurance providing apparatus 1 transmits to the worker terminal 3 an approval request for the change to the newly calculated insurance premium (S204).

When the worker, in response thereto, approves the newly calculated insurance premium through the worker terminal 3 (S205), the insurance providing apparatus 1 receives the approval, references the contract information DB 1B, and updates the insurance contract information through the update processing unit 14 (S206).

The updated information is transmitted from the insurance providing apparatus 1 to the personnel labor information management apparatus 2 (S207), and the personnel labor information management apparatus 2 that has received the updated information references the personnel labor information DB 2A and updates the contract information through the update processing unit 21 based on the updated information (S208).

Through this, the premium is also changed in accordance with changes in personnel labor information, and a reasonable premium corresponding to moment-by-moment personnel labor information is set for the worker.

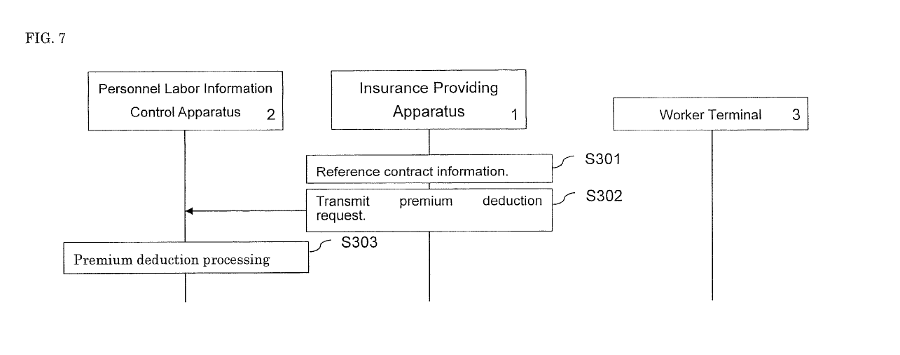

Next, an example of processing to deduct the premium set for the insurance from the wages of the worker will be described with reference to FIG. 7.

The insurance providing apparatus 1 references the contract information of the worker in the contract information DB 1B (S301), and then transmits a request to deduct the premium that has been set for the worker to the personnel labor information management apparatus 2 (S302).

In response thereto, the personnel labor information management apparatus 2 executes processing through the deduction processing unit 22 to reference the personnel labor information of the targeted worker, add the relevant insurance premium to the expense items to be deducted from the wages, etc. and deduct the insurance premium from the wages of the worker (S303).

Wages from which the premium has been deducted are paid to the worker in accordance with a prescribed settlement.

Through this, insurance premiums are automatically paid without the worker having to be aware of every single insurance, and thus convenience is provided.

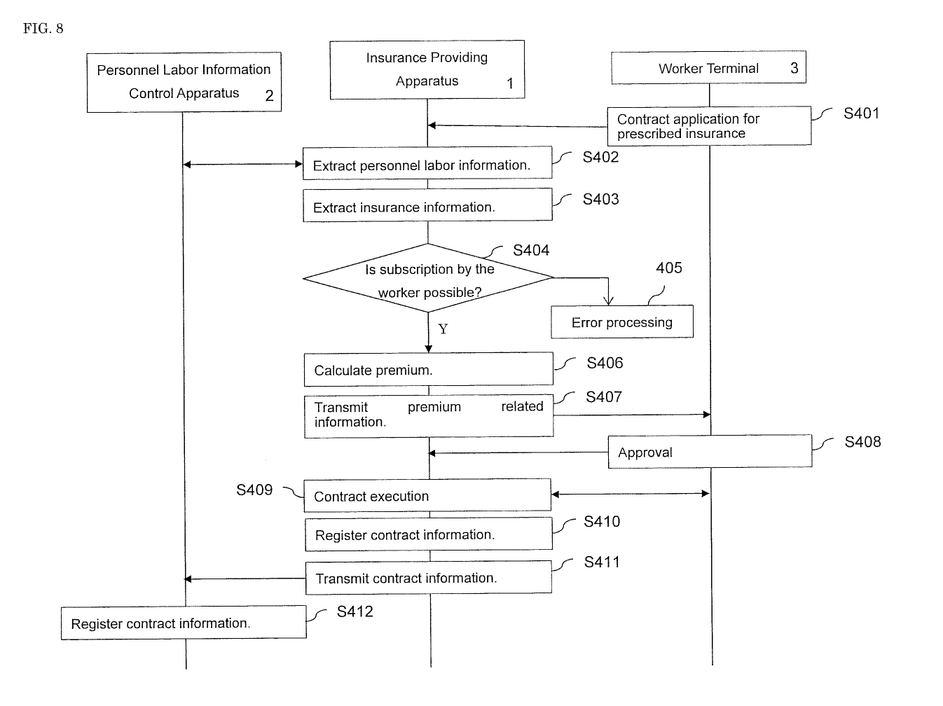

Next, another example of processing to offer insurance to a worker is described with reference to FIG. 8.

First, a contract application for a prescribed insurance is transmitted from the worker to the insurance providing apparatus 1 through the worker terminal 3 (S401).

In response thereto, the insurance providing apparatus 1 uses the extraction processing unit 11 to extract personnel labor information of the worker from the personnel labor information DB 2A of the personnel labor information management apparatus 2 (S402), and to extract insurance information for the prescribed insurance desired by the worker from the insurance information DB 1A (S403).

Furthermore, based on the personnel labor information of the worker, the determination processing unit 12 determines*² the possibility of subscription by the worker with regard to prescribed insurance information (S404). That is, the determination processing unit 12 determines whether the personnel labor information of the worker satisfies the subscription conditions set by the prescribed insurance.

As a result, if the worker does not satisfy the subscription conditions for the prescribed insurance, the worker is notified of this result and/or other procedures are conducted, and processing is ended (S405).

However, if the worker satisfies the subscription conditions for the prescribed insurance, the calculation processing unit 13 calculates the premium to be set for the worker for the prescribed insurance (S406).

This premium is calculated based on the personnel labor information of the worker and the premium calculation standard stipulated for the insurance.

In response thereto, information indicating that the worker can subscribe to the insurance desired by the worker, and information pertaining to the premium to be set for the insurance are transmitted to the worker terminal 3 (S407).

When the insurance providing apparatus 1 receives approval for the premium from the worker terminal 3 (S408), the insurance providing apparatus 1 executes an exchange of various procedures, etc. necessary for executing an insurance contract with the worker, and concludes the insurance contract (S409).

Information relating to the concluded insurance contract is registered in the contract information DB 1B (S410).

Furthermore, the contract information is provided to the personnel labor information management apparatus 2 (S411), and the personnel labor information management apparatus 2 that has received the contract information uses the update processing unit 21 to reference the personnel labor information DB 2A, and update and register the contract information in the personnel labor information of the worker (S412).

According to this example, the possibility of subscription by the worker to the insurance desired by the worker is determined, and if subscription is possible, a reasonable premium in accordance with the personnel labor information of the worker is set.

### REFERENCE SIGNS LIST

1 insurance providing apparatus
1A insurance information DB
1B contract information DB
11 extraction processing unit
12 determination processing unit
13 calculation processing unit
14 update processing unit
15 communication processing unit
2 personnel labor information management apparatus
2A personnel labor information DB
21 update processing unit
22 deduction processing unit
23 communication processing unit
3 worker terminal
NW network

1. An insurance providing apparatus for providing insurance that is based on personnel labor information specific to a worker, a premium being set for the worker according to the changing personnel labor information; wherein
the insurance providing apparatus is characterized in being configured so as to be capable of communicating through a network with a personnel labor information management apparatus having personnel labor information storage means in which personnel labor information specific to the worker is stored, the insurance providing apparatus comprising:
insurance information storage means in which is stored insurance information regarding insurance to be offered to the worker, the insurance information comprising details of the insurance, insurance subscription conditions based on the personnel labor information, and calculation standards for a premium to be set according to the personnel labor information;
determination processing means which references the personnel labor information storage means and the insurance information storage means, and determines the possibility of subscription of the worker to a prescribed insurance on the basis of the personnel labor information of the worker and subscription conditions for the insurance; and
calculation processing means, which for a case in which the worker satisfies subscription conditions for the prescribed insurance based on the results of the determination of the subscription possibility, references the personnel labor information storage means and the insurance information storage means, and calculates a premium to be imposed on the worker for the prescribed insurance on the basis of the premium calculation standard and the personnel labor information of the worker.

2. The insurance providing apparatus according to claim 1 configured so as to be capable of further communicating through a network with a worker terminal used by the worker, and further comprising:
application reception means for receiving an application regarding a contract for the prescribed insurance from the worker terminal for a case in which the worker satisfies the subscription conditions for the prescribed insurance based on the results of the determination of the possibility of subscription; and
contract information storage means for storing information of an insurance contract concluded according to the application.

3. The insurance providing apparatus according to claim 2, further comprising:
premium information transmission means for transmitting to the worker terminal, information relating to a premium newly calculated at each prescribed timing;
approval information reception means for receiving approval information relating to the newly calculated premium from the worker terminal; and
update processing means for updating and registering information relating to the approved premium in the contract information storage means;
the calculation processing means further referencing the personnel labor information storage means, the insurance information storage means, and the contract information storage means at every prescribed timing, and newly calculating a premium for insurance for which the contract has been concluded.

4. The insurance providing apparatus according to claim 2, further comprising:
deduction request transmission means for transmitting, to the personnel labor information management apparatus, information relating to the premium of the concluded insurance, along with a request to deduct the premium.

5. The insurance providing apparatus according to claim 3, further comprising:
deduction request transmission means for transmitting, to the personnel labor information management apparatus, information relating to the premium of the concluded insurance, along with a request to deduct the premium.

6. An insurance providing apparatus for providing insurance based on personnel labor information specific to a worker, a premium being set for the worker according to the changing personnel labor information; wherein
the insurance providing apparatus is characterized in being configured so as to be capable of communicating through a network with: a personnel labor information management apparatus having personnel labor information storage means in which personnel labor information specific to the worker is stored, and a worker terminal used by the worker; and the insurance providing apparatus comprises:
insurance information storage means in which is stored insurance information regarding insurance to be offered to the worker, the insurance information comprising details of the insurance, insurance subscription conditions based on the personnel labor information, and calculation standards for a premium to be set according to the personnel labor information;
determination processing means which references the personnel labor information storage means and the insurance information storage means, and determines the possibility of subscription of the worker to a prescribed insurance on the basis of the personnel labor information of the worker and subscription conditions for the insurance;
first calculation processing means, which for a case in which the worker satisfies subscription conditions for the prescribed insurance based on the results of the determination of the subscription possibility, references the personnel labor information storage means and the insurance information storage means, and calculates a premium to be imposed on the worker for the prescribed insurance on the basis of the premium calculation standard and the personnel labor information of the worker;
application reception means for receiving, from the worker terminal, an application regarding a contract for insurance for which the premium was calculated;
contract information storage means for storing information of an insurance contract concluded according to the application;
second calculation processing means which references, at every prescribed timing, the personnel labor information storage means, the insurance information storage means, and the contract information storage means, and newly calculates a premium for insurance for which the contract was concluded;
premium information transmission means for transmitting information relating to a premium newly calculated at each prescribed timing to the worker terminal;
approval information reception means for receiving approval information relating to the newly calculated premium from the worker terminal; and
update processing means for updating and registering information relating to the approved premium in the contract information storage means.

7. The insurance providing apparatus according to claim 5, further comprising:
contract information transmission means for transmitting the concluded or updated insurance contract information to the personnel labor information management apparatus.

8. An insurance providing method for providing insurance based on personnel labor information specific to a worker, a premium being set for the worker according to the changing personnel labor information;
the insurance being provided through a computer configured so as to be capable of communicating through a network with a personnel labor information management apparatus having personnel labor information storage means in which personnel labor information specific to the worker is stored, and
the computer having insurance information storage means in which is stored insurance information regarding insurance to be offered to the worker, the insurance information comprising details of the insurance, insurance subscription conditions based on the personnel labor information, and calculation standards for a premium to be set according to the personnel labor information;
wherein the insurance providing method is characterized by executing:
determination processing for referencing the personnel labor information storage means and the insurance information storage means, and determining the possibility of subscription of the worker to a prescribed insurance on the basis of the personnel labor information of the worker and subscription conditions for the insurance; and
calculation processing in which for a case in which the worker satisfies subscription conditions for the prescribed insurance based on the results of the determination of the subscription possibility, the personnel labor information storage means and the insurance information storage means are referenced, and a premium to be imposed on the worker for the prescribed insurance is calculated on the basis of the premium calculation standard and the personnel labor information of the worker.

9. An insurance providing method for providing insurance based on personnel labor information specific to a worker, a premium being set for the worker according to the changing personnel labor information;
the insurance being provided by a computer configured so as to be capable of communicating through a network with: a personnel labor information management apparatus having personnel labor information storage means in which personnel labor information specific to the worker is stored, and a worker terminal used by the worker, and
the computer having insurance information storage means in which is stored insurance information regarding insurance to be offered to the worker, the insurance information comprising details of the insurance, insurance subscription conditions based on the personnel labor information, and calculation standards for a premium to be set according to the personnel labor information;
wherein the insurance providing method is characterized in that the following are executed:
determination processing for referencing the personnel labor information storage means and the insurance information storage means, and determining the possibility of subscription of the worker to a prescribed insurance on the basis of the personnel labor information of the worker and subscription conditions for the insurance;
first calculation processing in which for a case in which the worker satisfies subscription conditions for the prescribed insurance based on the results of the determination of the subscription possibility, the personnel labor information storage means and the insurance information storage means are referenced, and a premium to be imposed on the worker for the prescribed insurance is calculated on the basis of the premium calculation standard and the personnel labor information of the worker;
application reception processing for receiving, from the worker terminal, an application regarding a contract for insurance for which the premium was calculated;
processing to store in contract information storage means, information of an insurance contract concluded according to the application;
second calculation processing for referencing, at every prescribed timing, the personnel labor information storage means, the insurance information storage means, and the contract information storage means, and newly calculating a premium for insurance for which the contract was concluded;
premium information transmission processing for transmitting information relating to a premium newly calculated at each prescribed timing to the worker terminal;
approval information reception processing for receiving approval information relating to the newly calculated premium from the worker terminal; and
update processing for updating and registering information relating to the approved premium in the contract information storage means.

10. A computer readable recording medium with a computer program recorded thereon for causing a computer to function as an insurance providing apparatus,
the computer being configured so as to be capable of communicating through a network with a personnel labor information management apparatus having personnel labor information storage means in which personnel labor information specific to a worker is stored, and
the computer having insurance information storage means in which is stored insurance information regarding insurance to be offered to the worker, the insurance information comprising details of the insurance, insurance subscription conditions based on the personnel labor information, and calculation standards for a premium to be set according to the personnel labor information;
wherein the computer program causes functioning as an insurance providing apparatus for providing insurance based on personnel labor information specific to the worker, a premium being set for the worker according to the changing personnel labor information;
and the computer program causes the computer to execute:
determination processing for referencing the personnel labor information storage means and the insurance information storage means, and determining the possibility of subscription of the worker to a prescribed insurance on the basis of the personnel labor information of the worker and subscription conditions for the insurance; and
calculation processing in which for a case in which the worker satisfies subscription conditions for the prescribed insurance based on the results of the determination of the subscription possibility, the personnel labor information storage means and the insurance information storage means are referenced, and a premium to be imposed on the worker for the prescribed insurance is calculated on the basis of the premium calculation standard and the personnel labor information of the worker.

11. A computer readable recording medium with a computer program recorded thereon for causing a computer to function as an insurance providing apparatus,
the computer being configured so as to be capable of communicating through a network with: a personnel labor information management apparatus having personnel labor information storage means in which personnel labor information specific to a worker is stored, and a worker terminal used by the worker, and
the computer having insurance information storage means in which is stored insurance information regarding insurance to be offered to the worker, the insurance information comprising details of the insurance, insurance subscription conditions based on the personnel labor information, and calculation standards for a premium to be set according to the personnel labor information;
wherein the computer program causes functioning as an insurance providing apparatus for providing insurance based on personnel labor information specific to the worker, a premium being set for the worker according to the changing personnel labor information;
and the computer program causes the computer to execute:
determination processing for referencing the personnel labor information storage means and the insurance information storage means, and determining the possibility of subscription of the worker to a prescribed insurance on the basis of the personnel labor information of the worker and subscription conditions for the insurance;
first calculation processing in which for a case in which the worker satisfies subscription conditions for the prescribed insurance based on the results of the determination of the subscription possibility, the personnel labor information storage means and the insurance information storage means are referenced, and a premium to be imposed on the worker for the prescribed insurance is calculated on the basis of the premium calculation standard and the personnel labor information of the worker;
application reception processing for receiving, from the worker terminal, an application regarding a contract for insurance for which the premium was calculated;
processing to store information of an insurance contract concluded according to the application in contract information storage means;
second calculation processing for referencing, at every prescribed timing, the personnel labor information storage means, the insurance information storage means, and the contract information storage means, and newly calculating a premium for insurance for which the contract was concluded;
premium information transmission processing for transmitting information relating to a premium newly calculated at each prescribed timing to the worker terminal;
approval information reception processing for receiving approval information relating to the newly calculated premium from the worker terminal; and
update processing for updating and registering information relating to the approved premium in the contract information storage means.

12. An insurance providing apparatus for providing insurance based on personnel labor information specific to a worker, a premium being set for the worker according to the changing personnel labor information; wherein
the insurance providing apparatus is characterized in being configured so as to be capable of communicating through a network with: a personnel labor information management apparatus having personnel labor information storage means in which personnel labor information specific to the worker is stored, and a worker terminal used by the worker, the insurance providing apparatus comprising:
insurance information storage means in which is stored insurance information regarding insurance to be offered to the worker, the insurance information comprising details of the insurance, insurance subscription conditions based on the personnel labor information, and calculation standards for a premium to be set according to the personnel labor information;
determination processing means which references the personnel labor information storage means and the insurance information storage means, and determines the possibility of subscription of the worker to a prescribed insurance on the basis of the personnel labor information of the worker and subscription conditions for the insurance;
first calculation processing means, which for a case in which the worker satisfies subscription conditions for the prescribed insurance based on the results of the determination of the subscription possibility, references the personnel labor information storage means and the insurance information storage means, and calculates a premium to be imposed on the worker for the prescribed insurance on the basis of the premium calculation standard and the personnel labor information of the worker;
application reception means for receiving, from the worker terminal, an application regarding a contract for insurance for which the premium was calculated;
contract information storage means for storing information of an insurance contract concluded according to the application;
second calculation processing means which references, at every prescribed timing, the personnel labor information storage means, the insurance information storage means, and the contract information storage means, and newly calculates a premium for insurance for which the contract was concluded;
premium information transmission means for transmitting information relating to a premium newly calculated at each prescribed timing to the worker terminal;
approval information reception means for receiving approval information relating to the newly calculated premium from the worker terminal; and
update processing means for updating and registering information relating to the approved premium in the contract information storage means.

13. An insurance providing method for providing insurance based on personnel labor information specific to a worker, a premium being set for the worker according to the changing personnel labor information;
the insurance being provided through a computer configured so as to be capable of communicating through a network with: a personnel labor information management apparatus having personnel labor information storage means in which personnel labor information specific to the worker is stored, and a worker terminal used by the worker, and
the computer having insurance information storage means in which is stored insurance information regarding insurance to be offered to the worker, the insurance information comprising details of the insurance, insurance subscription conditions based on the personnel labor information, and calculation standards for a premium to be set according to the personnel labor information;
wherein the insurance providing method is characterized in that the following are executed:
determination processing for referencing the personnel labor information storage means and the insurance information storage means, and determining the possibility of subscription of the worker to a prescribed insurance on the basis of the personnel labor information of the worker and subscription conditions for the insurance;
first calculation processing in which for a case in which the worker satisfies subscription conditions for the prescribed insurance based on the results of the determination of the subscription possibility, the personnel labor information storage means and the insurance information storage means are referenced, and a premium to be imposed on the worker for the prescribed insurance is calculated on the basis of the premium calculation standard and the personnel labor information of the worker;
application reception processing for receiving, from the worker terminal, an application regarding a contract for insurance for which the premium was calculated;
processing to store information of an insurance contract concluded according to the application in contract information storage means;
second calculation processing for referencing, at every prescribed timing, the personnel labor information storage means, the insurance information storage means, and the contract information storage means, and newly calculating a premium for insurance for which the contract was concluded;
premium information transmission processing for transmitting information relating to a premium newly calculated at each prescribed timing to the worker terminal;
approval information reception processing for receiving approval information relating to the newly calculated premium from the worker terminal; and
update processing for updating and registering information relating to the approved premium in the contract information storage means.

14. A computer readable recording medium with a computer program recorded thereon for causing a computer to function as an insurance providing apparatus,
the computer being configured so as to be capable of communicating through a network with: a personnel labor information management apparatus having personnel labor information storage means in which personnel labor information specific to a worker is stored, and a worker terminal used by the worker, and
the computer having insurance information storage means in which is stored insurance information regarding insurance to be offered to the worker, the insurance information comprising details of the insurance, insurance subscription conditions based on the personnel labor information, and calculation standards for a premium to be set according to the personnel labor information;
wherein the computer program causes functioning as an insurance providing apparatus for providing insurance based on personnel labor information specific to the worker, a premium being set for the worker according to the changing personnel labor information;
and the computer program causes the computer to execute:
determination processing for referencing the personnel labor information storage means and the insurance information storage means, and determining the possibility of subscription of the worker to a prescribed insurance on the basis of the personnel labor information of the worker and subscription conditions for the insurance;
first calculation processing in which for a case in which the worker satisfies subscription conditions for the prescribed insurance based on the results of the determination of the subscription possibility, the personnel labor information storage means and the insurance information storage means are referenced, and a premium to be imposed on the worker for the prescribed insurance is calculated on the basis of the premium calculation standard and the personnel labor information of the worker;
application reception processing for receiving, from the worker terminal, an application regarding a contract for insurance for which the premium was calculated;
processing to store in contract information storage means information of an insurance contract concluded according to the application;
second calculation processing for referencing, at every prescribed timing, the personnel labor information storage means, the insurance information storage means, and the contract information storage means, and newly calculating a premium for insurance for which the contract was concluded;
premium information transmission processing for transmitting to the worker terminal information relating to a premium newly calculated at each prescribed timing;
approval information reception processing for receiving approval information relating to the newly calculated premium from the worker terminal; and
update processing for updating and registering information relating to the approved premium in the contract information storage means.
